(19) United States
(12) Patent Application Publication
(10) Pub. No.: US 2018/0132034 A1
(43) Pub. Date: May 10, 2018

(54) CONTROLLED ARRAY LOUDSPEAKER

(71) Applicant: Gibson Innovations Belgium NV, leuven (BE)

(72) Inventors: Benoit Burette, Brussels (BE); Frederic Roskam, St. Albans (GB); Aymeric De-Vergie, Rixensart (BE); Bauke Janssens, Brussels (BE)

(21) Appl. No.: 15/570,327

(22) PCT Filed: Apr. 29, 2015
(86) PCT No.: PCT/EP2015/059261

§ 371 Date: Oct. 28, 2017

(51) Int. Cl. H04R 1/26; H04R 1/40; H04R 5/02; H04R 3/14; H04R 3/04; H04S 7/00

(52) U.S. Cl. CPC H04R 1/26; H04R 1/403; H04R 5/02; H04R 2201/025; H04R 3/04; H04S 7/30; H04R 3/14

(57) ABSTRACT

A controlled array loudspeaker comprising a plurality of acoustic drivers, each acoustic driver aligned along a common path and directed at an angle of rotation from an axis of the common path at a degree corresponding to the degree of audio frequency level output relative to the position along the common path of at least a first acoustic driver for frequencies in at least the critical voice band, and at least a second and a third acoustic driver for frequencies above the voice band.

### FIELD OF THE INVENTION

This invention relates generally to array loudspeaker arrangements, and more particularly to controlled array loudspeakers.

### BACKGROUND OF THE INVENTION

Customer demand for mono-block audio rendering systems comprising array loudspeakers has increased in recent years. Such audio rendering systems have several benefits over earlier multi-component sound rendering systems including compact footprints and elimination of interconnecting loudspeaker boxes and main units. Additionally, free standing single sound towers, such as PHILIPS DCM5090 made by Koninklijke Philips N.V. of Amsterdam, Netherlands, offer an additional advantage of requiring no further supporting furniture for placing in a room.

Mono-block audio rendering systems have many acoustic challenges to reproduce stereo audio content. The left and right stereo channels are typically rendered by dedicated amplifiers and speaker drivers, sometimes with common large “woofer” for the low frequencies. However, the spacing required between the left and right speakers to achieve stereo channels is both to narrow for an appropriate stereo listening experience such as in accordance with the equilateral triangle rule, and creates strong interferences between the two or more sources of sound waves. Attempts have been made to overcome these problems, however, there remain limitations with appropriate stereo listening experience due to inadequate “sweet spot” and coloration.

There is a need for an array loudspeaker that addresses or at least alleviates the above mentioned problems.

### SUMMARY OF THE INVENTION

An aspect of the invention is an array loudspeaker comprising a plurality of acoustic drivers, each acoustic driver aligned along a common path and directed at an angle of rotation from an axis of the common path at a degree corresponding to the degree of audio frequency level output relative to the position along the common path of at least a first acoustic driver for frequencies in at least the critical voice band, and at least a second and a third acoustic driver for frequencies above the voice band.

An embodiment of the invention has at least the second or third acoustic driver having an angle of rotation of at least +/−45 degrees from the first acoustic driver for frequencies in the critical voice band.

In an embodiment of the invention, the first acoustic driver is for frequencies in the critical voice band of a sum of a left and a right stereo channel, and the second and third acoustic drivers are for frequencies above the critical voice band in the left and right stereo channels respectively.

An embodiment of the invention has at least the second acoustic driver for left stereo channel content frequencies above the critical voice band and has an angle of rotation of at least 45 degrees from the first acoustic driver, and at least the third acoustic driver for right stereo channel content frequencies above the critical voice band and has an angle of rotation of at least −45 degrees from the first acoustic driver.

In an embodiment of the invention, the array loudspeaker has further acoustic drivers, the first acoustic driver for frequencies in the critical voice band of a sum of a plurality of audio channels, and each other acoustic driver for frequencies above the critical voice band in respective audio channels. The audio channels can form a multi-channel or surround sound audio input, or a stereo audio input.

In an embodiment of the invention, the first acoustic driver is for frequencies in the critical voice band of one audio channel, and the second and third acoustic drivers are for frequencies above the critical voice band in said one audio channel. The audio channel can be one channel of a stereo, multi-channel or surround sound audio input.

An embodiment of the invention has each acoustic driver having an acoustic centre with an axis and a span forming an acoustic centre plane at the acoustic centre for determining the direction of an acoustic beaming.

An embodiment of the invention has each acoustic driver aligned along the common path at the acoustic centre.

An embodiment of the invention has an audio processor comprising an array of filters comprising a plurality of acoustic filters for receiving and processing audio input to the plurality of acoustic drivers corresponding to the audio frequency level output.

In an embodiment of the invention, the plurality of acoustic filters comprise at least one acoustic filter for frequencies in the critical voice band of a sum of a plurality of audio channels, and at least a respective one acoustic filter for frequencies above the critical voice band in each audio channel. The audio channels can form a multi-channel or surround sound audio input, or a stereo audio input.

In an embodiment of the invention, the plurality of acoustic filters comprise at least one acoustic filter for frequencies in the critical voice band of a sum of a left and a right stereo channel, at least one acoustic filter for left stereo channel content frequencies above the critical voice band, and at least one acoustic driver for right stereo channel content for frequencies above the critical voice band.

In an embodiment of the invention, the plurality of acoustic filters comprise at least one acoustic filter for frequencies in the critical voice band of one audio channel, with the other acoustic filters for frequencies above the critical voice band in said one audio channel. The audio channel can be one channel of a stereo, multi-channel or surround sound audio input.

An embodiment of the invention has the maximum angle of rotation of 30 degrees for an acoustic driver for critical voice band frequencies.

An embodiment of the invention has the maximum angle of rotation between 70 and 90 degrees for an acoustic driver for above critical voice band frequencies.

An embodiment of the invention has the common path rectilinear and the acoustic centers of each acoustic driver vertically aligned.

An embodiment of the invention has the critical voice band frequency in the range of 1 kHz to 5 kHz.

An embodiment of the invention has five acoustic drivers each driver directed at a different angle of rotation from an axis forming a helical array aligned along a rectilinear common path.

An embodiment of the invention has at least one acoustic driver for frequencies in the critical voice band is positioned in the center of the array of acoustic drivers. The acoustic drivers at the either end of the array of acoustic drivers may be for stereo channels for frequencies above the critical voice band for left and right stereo channels respectively.

An embodiment of the invention has the spacing between each acoustic driver is less than 7 cm.

In an embodiment of the invention, the spacing between each acoustic driver is at least c/(2*fₘₐₓ sin(αₘₐₓ)) with fₘₐₓ being a maximum frequency in an audio input, and αₘₐₓ being a maximum angle of incidence.

In an embodiment of the invention, a total length of the array loudspeaker is linked to the lowest frequency where beaming can occur. For example, for beaming without any angle, f_{low}=c/L, where L is the total length of the array loudspeaker and f_{low} is the lowest frequency desired to start beaming.

An embodiment of the invention has a support structure for supporting the plurality of acoustic drivers.

### BRIEF DESCRIPTION OF THE DRAWINGS

The accompanying drawings incorporated herein and forming a part of the specification illustrate several aspects of the present invention and, together with the description, serve to explain the principles of the invention. While the invention will be in connection with certain embodiments, there is no intent to limit the invention to those embodiments described. On the contrary, the intent is to cover all alternatives, modifications and equivalents as included within the scope of the invention as defined by the appended claims. In the drawings:

FIG. 1 is a simplified schematic view of a mono-block audio rendering system showing a controlled array loudspeaker system with acoustic driver array exposed to show the orientation of the acoustic drivers in the array in accordance with an embodiment of the invention;

FIG. 2-6 are top plan views of acoustic drivers of the controlled array loudspeaker showing the angle orientation rotationally offset from a common path along the array of acoustic drivers in accordance with an embodiment of the invention;

FIG. 7-10 are top plan views of adjacent acoustic drivers, one below depicted in dashed lines and the above adjacent acoustic driver depicted in solid lines with each acoustic centre of the acoustic driver aligned along the path of the array of acoustic drivers showing the angle of rotational offset between the adjacent acoustic drivers showing the placement of the acoustic drivers in the controlled array loudspeaker system in accordance with an embodiment of the invention;

FIG. 11a shows a sound processor system for processing audio content in a controlled array loudspeaker comprising mono and stereo content in accordance with an embodiment of the invention;

FIG. 11b shows a sound processor system for processing audio content in a controlled array loudspeaker comprising content from one stereo channel in accordance with an embodiment of the invention; and

FIG. 12 is a graph showing the array filters frequency response in accordance with an embodiment of the invention.

### DETAILED DESCRIPTION

A controlled array loudspeaker comprising a plurality of acoustic drivers is disclosed. Each acoustic driver is aligned along a common path and directed at an angle of rotation from an axis of the common path at a degree corresponding to the degree of audio frequency level output relative to the position along the common path of at least a first acoustic driver for frequencies in at least the critical voice band. Additionally, at least a second and a third acoustic driver of the plurality of acoustic drivers are for frequencies above the voice band.

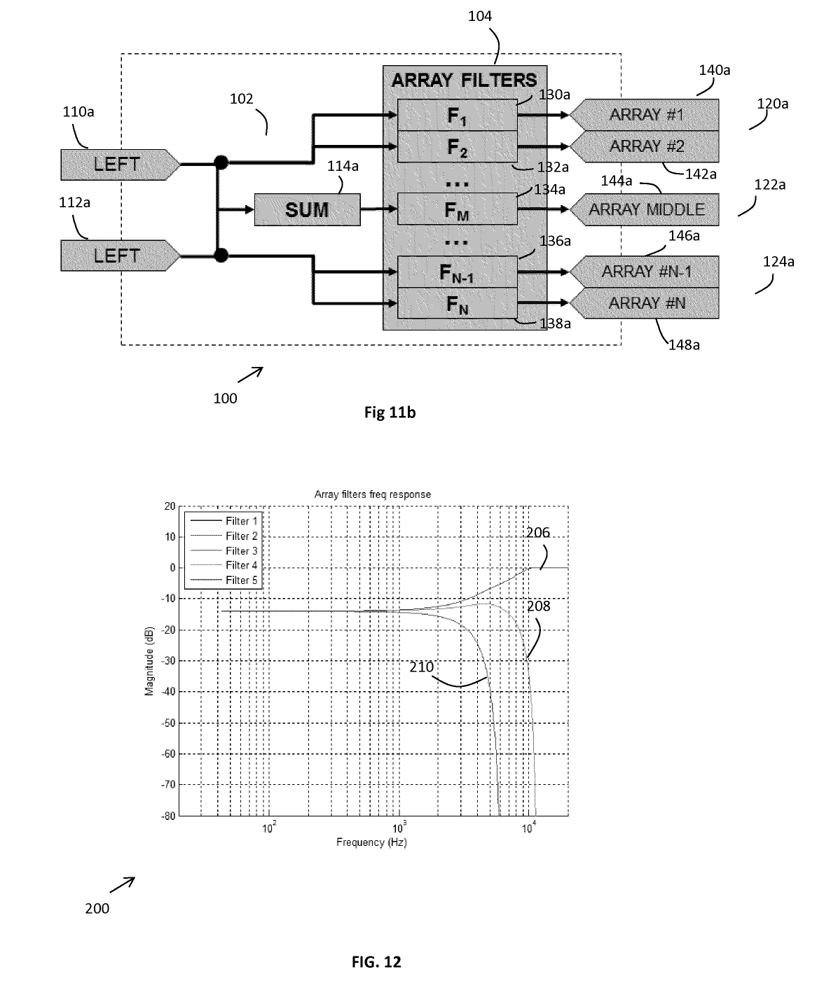

In one embodiment, as best shown in FIG. 11a, the first acoustic driver is for frequencies in the critical voice band of a sum of a left and a right stereo channel, and the second and third acoustic drivers are for frequencies above the critical voice band in the left and right stereo channels respectively. The acoustic drivers in the voice band frequencies create a coherent and mono beam of sound, and the stereo sound is projected to the sides by combination of acoustic drivers at different angles from the acoustic drivers for the mono beam of sound.

In other embodiments, there are more than two audio channels, that is, more than a left and a right stereo channel. In particular, there may be various numbers of audio channels corresponding to, for example, 5.1 or 7.1 multi-channel or surround sound. In such embodiments, the first acoustic driver for frequencies in the critical voice band of a sum of a plurality of audio channels, and each other acoustic driver for frequencies above the critical voice band in respective audio channels.

In another embodiment, as best shown in FIG. 11b, the first acoustic driver is for frequencies in the critical voice band of one stereo channel, and the second and third acoustic drivers are for frequencies above the critical voice band in said one stereo channel. This embodiment can be used in implementations where, for example, one array loudspeaker is dedicated to a left stereo channel and another array loudspeaker is dedicated to a right stereo channel. In such implementations, the array loudspeakers are placed in appropriate positions in a room to provide the desired acoustic performance.

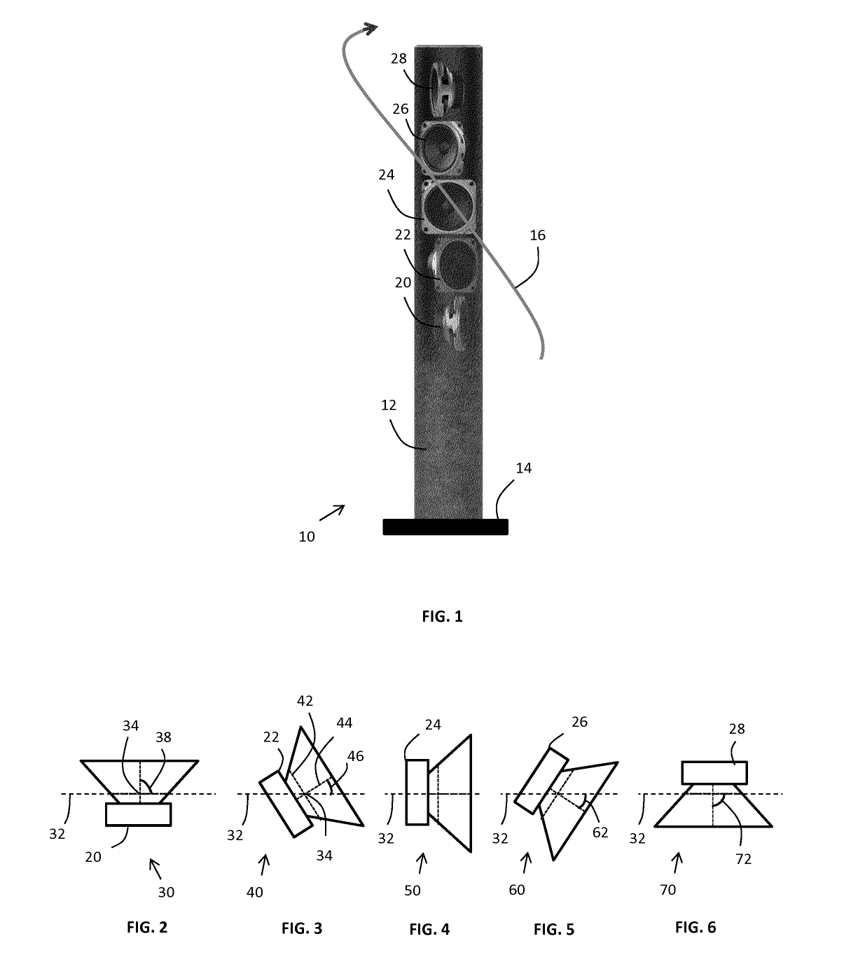

FIG. 1 is a simplified schematic view of a mono-block audio rendering system showing a controlled array loudspeaker system with acoustic driver array exposed to show the orientation of the acoustic drivers in the array in accordance with an embodiment of the invention. The controlled array loudspeaker has a loudspeaker support structure 12 for supporting the array of acoustic drivers in a fixed position and orientation relative a common path. The support structure comprises a base 14 for standing on the floor of a room. The support structure may take the form of a mono-block home audio tower, multi-towers, mini table-top towers, and the like.

In this embodiment, the array of acoustic drivers are positioned in a helical array 16, with five acoustic drivers positioned adjacent each other along a rectilinear vertical path. It will be appreciated that the array may comprise different numbers of acoustic drivers, such as three, four, five, six, seven or more, and the common path the acoustic drivers are aligned along may be other paths than rectilinear vertical paths. In this embodiment, the five acoustic driver array comprises first acoustic driver 20, second acoustic driver 22, third acoustic driver 24, fourth acoustic driver 26, and fifth acoustic driver 28.

FIG. 2-6 are top plan views of acoustic drivers of the controlled array loudspeaker showing the angle orientation rotationally offset from a common path along the array of acoustic drivers in accordance with an embodiment of the invention. More specifically, FIG. 2 is a top plan view of a first acoustic driver showing the angle orientation rotationally offset from a path along the array of acoustic drivers with an acoustic centre of the first acoustic driver in accordance with an embodiment of the invention. The start line or 0° line 32 determining the rotational offset is shown as dashed line 32 in each of FIG. 2-6. In this embodiment, for example, the 0° line for determining the rotational offset of the acoustic driver passes through the centre points of the top and bottom circular bases of the frustum/frusto-conical shape formed by the middle section or third acoustic driver 24. The acoustic centre 34 point is along the vertical path of the speaker array. In this embodiment, the array path is a rectilinear vertical path and the origin centre of rotation or point of rotation for each acoustic driver is at the acoustic centre. The first acoustic driver 20 has an angle of rotational offset 36 of 90°

FIG. 3 is a top plan view of a second acoustic driver 22 showing the angle orientation rotationally offset from a vertical path along the array of acoustic drivers with an acoustic centre of the second acoustic driver 22. The span 42 at the acoustic centre and axis 44 of acoustic driver is shown by dashed lines. The second acoustic driver 22 has an angle of rotational offset 46 is 45°.

FIG. 4 is a top plan view of a third acoustic driver 24 showing the angle orientation rotationally offset from a vertical path along the array of acoustic drivers with an acoustic centre of the third acoustic driver. The third acoustic driver 24 has an angle of rotational offset is zero (0°)

FIG. 5 is a top plan view of a fourth acoustic driver 26 showing the angle orientation rotationally offset from a vertical path along the array of acoustic drivers with an acoustic centre of the fourth acoustic driver. The fourth acoustic driver 26 has an angle of rotational offset 62 is −45°.

FIG. 6 is a top plan view of a fifth acoustic driver 28 showing the angle orientation rotationally offset from a vertical path along the array of acoustic drivers with an acoustic centre of the fifth acoustic driver in accordance with an embodiment of the invention. The fourth acoustic driver 28 has an angle of rotational offset is −90°.

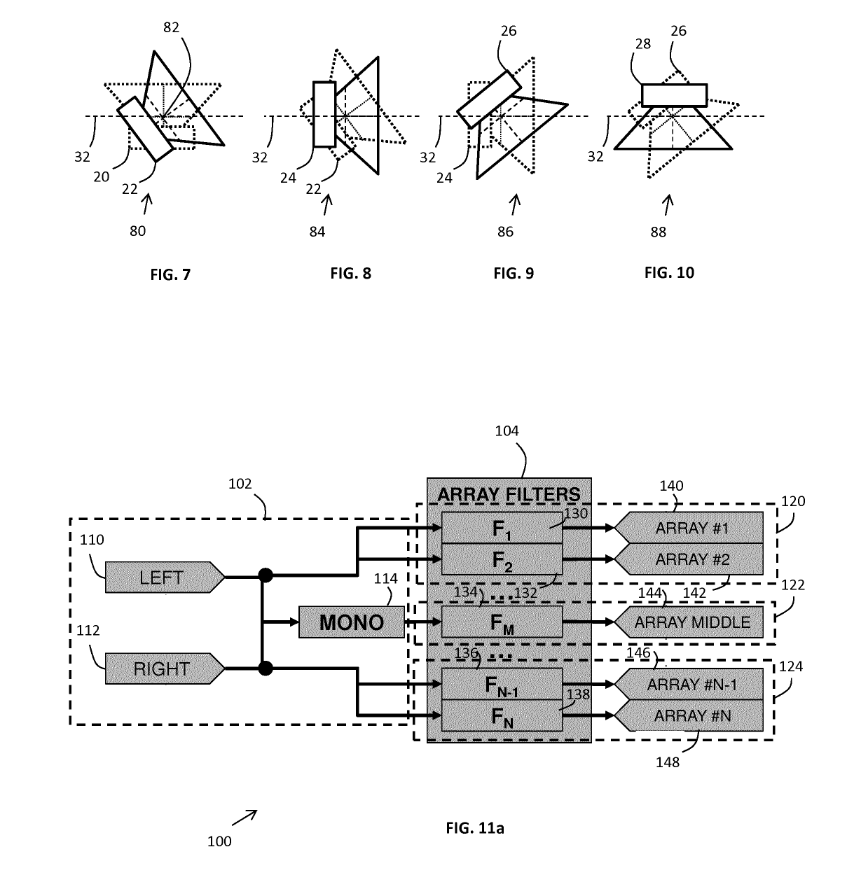

FIG. 7-10 are top plan views of adjacent acoustic drivers, one below depicted in dashed lines and the above adjacent acoustic driver depicted in solid lines with each acoustic centre of the acoustic driver aligned along the path of the array of acoustic drivers showing the angle of rotational offset between the adjacent acoustic drivers showing the placement of the acoustic drivers in the controlled array loudspeaker system in accordance with an embodiment of the invention;

More specifically, FIG. 7 is a top plan view of the first acoustic driver 20 (depicted in dashed lines) below, and the second acoustic driver 22 (depicted in solid lines) the above adjacent acoustic driver. Each acoustic centre of the acoustic drivers are aligned along the path of the array of acoustic drivers with the first acoustic driver 20 having an angle of rotational offset of 90° and the second acoustic driver 22 having an angle of rotational offset of 45°. The point of rotational axis 82 for each acoustic driver is shown aligned.

FIG. 8 is a top plan view of the second acoustic driver 22 (depicted in dashed lines) and the third acoustic driver 24 (depicted in solid lines) with each acoustic centre of the acoustic driver aligned along the path of the array of acoustic drivers with the second acoustic driver 22 having an angle of rotational offset of 45° and the third acoustic driver 24 having a zero (0°) angle of rotational offset.

FIG. 9 is a top plan view of the third acoustic driver 24 (depicted in dashed lines) and the fourth acoustic driver 26 (depicted in solid lines) with each acoustic centre of the acoustic driver aligned along the path of the array of acoustic drivers with the third acoustic driver 24 having a zero (0°) angle of rotational offset and the fourth acoustic driver 26 having a −45° angle of rotational offset.

FIG. 10 is a top plan view of the fourth acoustic driver 26 (depicted in dashed lines) and the fifth acoustic driver 28 (depicted in solid lines) with each acoustic centre of the acoustic driver aligned along the path of the array of acoustic drivers with the fourth acoustic driver 26 having an angle of rotational offset of 45° and the fifth acoustic driver 28 having a −90° angle of rotational offset.

In this embodiment, a five acoustic driver array is shown, with each acoustic driver having the angle of rotation of 90°, 45°, 0, −45°, −90° for the acoustic drivers in the array, respectively. It will be appreciated that other angles may be selected, such as 70°, 30°, 0, −30°, −70°; or 70°, 0°, 0, 0°, −70°; or 70°, −70°, 0, −30°, −30°; or the like. It will appreciated that the acoustic drivers arranged for above voice band for stereo content may be arranged at other positions in the array other than the extreme positions. Likewise, the acoustic drivers arranged for voice band frequencies may also be at positions in the array other than in the middle position. Filtering and position of the acoustic drivers are designed to provide a sound beam with constant width along the respective working frequency range, defined by the array total length and minimal spacing between the acoustic drivers.

FIG. 11a shows a sound processor system 100 for processing audio content in a controlled array loudspeaker comprising mono and stereo content in accordance with an embodiment of the invention. The sound processor system 100 comprises audio content inputs 102 and array filters 104. Audio content inputs comprise stereo left source content input 110, stereo right source content input 112, and mono source content input 114. The mono source content input is the result of summing the stereo left and stereo right source content inputs. The sound processor system 100 comprises outputs comprising stereo left array acoustic driver output channel 120, mono array acoustic driver output channel 122, and stereo right array acoustic driver output channel 124. The array filters comprise stereo left first filter in left stereo filter array 130, stereo left second filter in left stereo filter array 132, mono filter in mono filter array (m) 134, stereo right first filter (n−1) in right stereo filter array 136, and stereo right second filter (n) in right stereo filter array 138.

The processed audio content is filtered to the appropriate acoustic driver in the speaker array. The first processed left stereo content 140 is provided to the designated acoustic driver 28 in acoustic driver array 140 of this embodiment. Similarly, the second processed left stereo content 142 to designated acoustic driver 26 in the acoustic driver array 142. The processed mono content (m) 144 is for acoustic driver 24. The first processed right stereo content (n−1) 146 is for designated acoustic driver 22, and the second processed right stereo content (n) 148 is for designated acoustic driver 20 in acoustic driver array.

In this arrangement shown in FIG. 11a, the combined processing is achieved of the voice band frequencies and above voice band frequencies. The filters shown may be considered a superposition of the two elements described with the controlled beam array filters for voice band frequencies, and the high frequency of left and right channels being directed to the extreme drives at the top and bottom of the acoustic driver array. The acoustic filters may comprise a set of finite impulse response (FIR) filters with low pass response, except for the center acoustic driver, in order to produce a beam with attenuated secondary lobes and constant beaming angle over a given frequency range.

FIG. 11b shows a similar sound processor system to FIG. 11b except that instead of the audio inputs 102 comprising stereo left source content input 110 and stereo right source content input 112, the audio inputs comprise two stereo left source content inputs 110a and 112a. Also, instead of the mono source content input 114, a sum 114a of the two stereo left source content inputs is provided. The sound processor system 100 comprises outputs comprising a first stereo left array acoustic driver output channel 120a, sum array acoustic driver output channel 122a, and a second stereo left array acoustic driver output channel 124a. The array filters comprise stereo left first filter in left stereo filter array 130a, stereo left second filter in left stereo filter array 132a, sum filter in sum filter array (m) 134a, stereo left third filter (n−1) in left stereo filter array 136a, and stereo left fourth filter (n) in left stereo filter array 138a.

The processed audio content is filtered to the appropriate acoustic driver in the speaker array. The first processed left stereo content 140a is provided to the designated acoustic driver 28 in acoustic driver array 140a of this embodiment. Similarly, the second processed left stereo content 142a to designated acoustic driver 26 in the acoustic driver array 142a. The processed sum content (m) 144a is for acoustic driver 24. The third processed left stereo content (n−1) 146a is for designated acoustic driver 22, and the fourth processed left stereo content (n) 148a is for designated acoustic driver 20 in acoustic driver array.

In this arrangement shown in FIG. 11b, the combined processing is achieved of the voice band frequencies and above voice band frequencies. The filters shown may be considered a superposition of the two elements described with the controlled beam array filters for voice band frequencies, and the high frequency of the left channel being directed to the extreme drives at the top and bottom of the acoustic driver array. The acoustic filters may comprise a set of finite impulse response (FIR) filters with low pass response, except for the center acoustic driver, in order to produce a beam with attenuated secondary lobes and constant beaming angle over a given frequency range.

In these embodiments, the alignment of the acoustic center of the acoustic driver along a vertical line produces a beam of sound in a vertical plane for the mid to high frequencies, while the acoustic drivers to either side of the center or middle acoustic driver beam the high frequencies to the sides, in particular when the acoustic drivers become highly directive.

The center or middle acoustic drivers for frequencies in the voice band face the listener. The center of the vertical array may be placed at the natural height for the listener's ears. For example, 1.3 meters is a height from the floor the middle acoustic driver may be positioned for covering listeners in both seated and standing up positions, which is also a good height to beam mono audio content above most furniture.

In an embodiment, the acoustic driver array maximum angle of rotation for acoustic drivers with above the voice band may be between 70 and 90 degrees. It will be appreciated that a lower value may reduce sensibly the widening effect, while a higher value may deteriorate the main vertical beam.

The spacing and total number of drivers may vary, however, in an embodiment the voice band frequency range is (1 kHz-5 kHz). For example, in analogy with time-domain Fourier analysis, to avoid spatial aliasing the distance between drivers should be at least c/(2*fₘₐₓ sin(αₘₐₓ)) with fₘₐₓ being the maximum frequency in the signal, and αₘₐₓ being the maximum angle of incidence. In this embodiment fₘₐₓ is at least 5 kHz, and the maximum angle is 30 degrees, which is linked to ceiling first reflection, and the spacing between each adjacent acoustic driver is at the most 7 cm.

In an embodiment, the total length of the acoustic driver array is linked to the lowest frequency where beaming can occur, for beaming without any angle, f_{low}=c/L, where L is the total length and f_{low} is the lowest frequency desired to start beaming. For example, to reach 1 kHz or below, L may be 34 cm. It will be appreciated that if this figure may be larger if windowing is applied.

In the sound processor, the acoustic driver array may be used for controlled beaming in the vertical plane covering the voice band of 1 kHz-5 kHz. All of the acoustic drivers may be used for covering the voice band, lower frequencies, while controlled beaming in higher frequencies, i.e. above voice band of 5 kHz using the speakers at the extremes of the acoustic driver array, i.e. top and bottom, using the natural directivity of acoustic drivers at those frequencies. Such acoustic drivers may be approximately 1.5 inches (3.81 cm) or larger.

For the controlled beaming in the vertical plane over the voice range, it is intended to reduce unwanted reflections from floor and ceiling, which adds coloration to the sound and reduces the perception of width. Strong first early reflections may come from the floor and/or ceiling. Additionally, a lower attenuation per meter inside larger rooms may be achieved with this embodiment.

Producing a wide stereo sound stage, high frequencies, i.e. above the voice range, are beamed to the sides using the natural directivity of the speaker drivers. Additional typical widening processing may also be used.

FIG. 12 is a graph 200 showing the array filters frequency response in accordance with an embodiment of the invention. The x-axis is in frequency (Hz) and the y-axis is in magnitude (dB). Line 206 is the frequency response of filter 3, line 208 is the frequency response of filter 4, and line 210 is the frequency response of filter 5.

Embodiments of the invention have been described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by the applicable law. Moreover, any combination of the above-described elements in all possible variations thereof is encompassed by the invention unless otherwise indicated herein or otherwise clearly contradicted by context.

1. An array loudspeaker comprising: a plurality of acoustic drivers, each acoustic driver aligned along a common path and directed at an angle of rotation from an axis of the common path at a degree corresponding to the degree of audio frequency level output relative to the position along the common path of at least a first acoustic driver for frequencies in at least the critical voice band, and at least a second and a third acoustic driver for frequencies above the voice band.

2. The array loudspeaker of claim 1 wherein at least the second or third acoustic driver has an angle of rotation of at least +/−45 degrees from the first acoustic driver for frequencies in the critical voice band.

3. The array loudspeaker of claim 1 wherein the first acoustic driver is for frequencies in the critical voice band of a sum of a left and a right stereo channel, and the second and third acoustic drivers are for frequencies above the critical voice band in the left and right stereo channels respectively.

4. The array loudspeaker of claim 3 wherein at least the second acoustic driver is for left stereo channel content frequencies above the critical voice band and has an angle of rotation of at least 45 degrees from the first acoustic driver, and at least the third acoustic driver is for right stereo channel content frequencies above the critical voice band and has an angle of rotation of at least −45 degrees from the first acoustic driver.

5. The array loudspeaker of claim 1 having further acoustic drivers, the first acoustic driver for frequencies in the critical voice band of a sum of a plurality of audio channels, and each other acoustic driver for frequencies above the critical voice band in respective audio channels.

6. The array loudspeaker of claim 1 wherein the first acoustic driver is for frequencies in the critical voice band of one audio channel, and the second and third acoustic drivers are for frequencies above the critical voice band in said one audio channel.

7. The array loudspeaker of claim 1 wherein each acoustic driver has an acoustic centre with an axis and a span forming an acoustic centre plane at the acoustic centre for determining the direction of an acoustic beaming.

8. The array loudspeaker of claim 7 where each acoustic driver is aligned along the common path at the acoustic centre.

9. The array loudspeaker of claim 1 further comprising an audio processor comprising an array of filters comprising a plurality of acoustic filters for receiving and processing audio input to the plurality of acoustic drivers corresponding to the audio frequency level output.

10. The array loudspeaker of claim 9 wherein the plurality of acoustic filters comprise at least one acoustic filter for frequencies in the critical voice band of a sum of a plurality of audio channels, and at least a respective one acoustic filter for frequencies above the critical voice band in each audio channel.

11. The array loudspeaker of claim 9 wherein the plurality of acoustic filters comprise at least one acoustic filter for frequencies in the critical voice band of a sum of a left and a right stereo channel, at least one acoustic filter for left stereo channel content frequencies above the critical voice band, and at least one acoustic driver for right stereo channel content for frequencies above the critical voice band.

12. The array loudspeaker of claim 9 wherein the plurality of acoustic filters comprise at least one acoustic filter for frequencies in the critical voice band of one audio channel, with the other acoustic filters for frequencies above the critical voice band in said one audio channel.

13. The array loudspeaker of claim 1 wherein the maximum angle of rotation is 30 degrees for an acoustic driver for critical voice band frequencies.

14. The array loudspeaker of claim 1 wherein the maximum angle of rotation is between 70 and 90 degrees for an acoustic driver for above critical voice band frequencies.

15. The array loudspeaker of claim 1 wherein the common path is rectilinear and the acoustic centers of each acoustic driver is vertically aligned.

16. The array loudspeaker of claim 1 wherein the critical voice band frequency is in the range of 1 kHz to 5 kHz.

17. The array loudspeaker of claim 1 wherein the plurality of acoustic drivers comprises five acoustic drivers each driver directed at a different angle of rotation from an axis forming a helical array aligned along a rectilinear common path.

18. The array loudspeaker of claim 17 wherein the at least one acoustic driver for frequencies in the critical voice band is positioned in the center of the array of acoustic drivers.

19. The array loudspeaker of claim 17 wherein the acoustic drivers at the either end of the array of acoustic drivers are for stereo channels for frequencies above the critical voice band for left and right stereo channels respectively.

20. The array loudspeaker of claim 1 wherein the spacing between each acoustic driver is less than 7 cm.

21. The array loudspeaker of claim 1 wherein the spacing between each acoustic driver is at least c/(2*fₘₐₓ sin(αₘₐₓ)) with fₘₐₓ being a maximum frequency in an audio input, and αₘₐₓ being a maximum angle of incidence.

22. The array loudspeaker of claim 1 wherein a total length of the array loudspeaker is linked to the lowest frequency where beaming can occur.

23. The array loudspeaker of claim 22 wherein for beaming without any angle, f_{low}=c/L, where L is the total length of the array loudspeaker and f_{low} is the lowest frequency desired to start beaming.

24. The array loudspeaker of claim 1 further comprising a support structure for supporting the plurality of acoustic drivers.
